(19) United States
(12) Patent Application Publication
(10) Pub. No.: US 2010/0214471 A1
(43) Pub. Date: Aug. 26, 2010

(54) AN ADAPTER FOR USE WITH A DIGITAL TO ANALOGUE TELEVISION SIGNAL DECODER

(75) Inventor: Paul Fellows, Cambridge (GB)

Correspondence Address: KNOBBE MARTENS OLSON & BEAR LLP, 2040 MAIN STREET, FOURTEENTH FLOOR, IRVINE, CA, 92614, US

(73) Assignee: AMINO HOLDINGS LTD, Cambridge (GB)

(21) Appl. No.: 12/095,998

(22) PCT Filed: Dec. 12, 2006
(86) PCT No.: PCT/GB06/04653

§ 371 Date: Sep. 25, 2009

(30) Foreign Application Priority Data
Dec. 12, 2005 (GB) 0525241.6

(51) Int. Cl. H04N 7/01

(52) U.S. Cl. 348/441; 348/E07.003

(57) ABSTRACT

An adapter for use with a digital to analogue television signal decoder, the adapter comprising input means for receiving a digital video stream encoded according to a first format at a first bit rate, conversion means for converting the received digital video stream from the first format to a second format different from the first, and output means for outputting a converted digital video stream encoded according to the second format at a second bit rate higher than the first.

This invention relates to an adapter for use with a digital to analogue television signal decoder, and in particular to an adapter for use with a set top box.

Set top boxes are generally used to provide access to digital television programming. Typically, a set top box receives a television programme signal through a network as an encoded digital video stream, converts this into an analogue television signal and outputs the analogue television signal to a conventional television set for viewing.

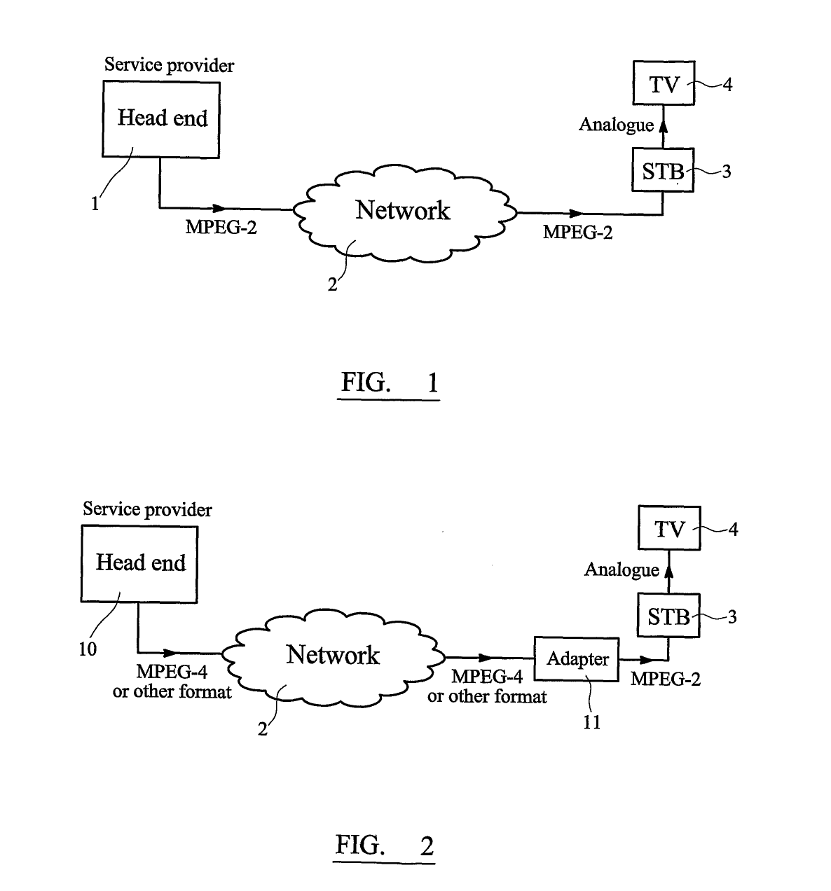

An example of such a known set top box arrangement to access digital television over a network is shown in FIG. 1. A television service provider 1 transmits a digital television signal through a network 2 as an encoded digital video stream in MPEG-2 format. This encoded digital video stream is received by a set top box (STB) 3 which converts it into an analogue television signal. The analogue television signal is then output by the set top box 3 to a conventional television 4 for viewing by a user. Similar known arrangements use set top boxes to access digital television signals sent by other means, such as satellite or terrestrial broadcasting.

MPEG-2 is a video standard developed by Moving Pictures Expert Group, and is the most commonly used format for encoding digital video streams.

Set top boxes are also commonly used to control access to conditional access digital television programming such as subscription only or pay per view services. In this case the set top box is arranged to decrypt a received encrypted digital signal for display only if a required authorisation has been given. One way in which this is achieved for subscription only services is for the set top box to be provided with an adapter allowing communication with a smart card and being arranged to obtain the necessary decryption keys from a smart card which is issued only to subscribers.

As a result, set top boxes are relatively complex and costly devices.

A number of new, more efficient encoding methods for delivering digital video streams are being proposed and developed to replace existing methods including the most popular MPEG-2 format. However, there is a problem that existing set top boxes will not be compatible with new encoding methods and will have to be replaced. Such replacement will impose a large cost on the users or service operators owning the very large number of existing set top boxes. This cost acts as a disincentive to use of new coding techniques. This problem is particularly severe for providers of subscription or pay per view television services because of the need to replace all of their subscribers set top boxes before they can stop providing services using current encoding methods and the risk of disruption of subscriber payments during any changeover.

This invention was made in an attempt to solve his problem, at least in part.

In a first aspect, this invention provides an adapter for use with a digital to analogue television signal decoder, the adapter comprising input means for receiving a digital video stream encoded according to a first format at a first bit rate, conversion means for converting the received digital video stream from the first format to a second format different from the first, and output means for outputting a converted digital video stream encoded according to the second format at a second bit rate higher than the first.

The present invention overcomes the problem identified above by providing an intermediate adapter able to convert the video streams encoded using a new format into an older format which the existing legacy set top box can understand and decode, typically the MPEG-2 format, without losing any of the original quality levels. By employing the intermediate adapter of the present invention it is possible to both extend the life of existing set-top boxes and allow existing set top boxes to work with new and future technologies, for example to take advantage of lower bit rate broadcast streams. As a result, it is not necessary for existing set top boxes to be replaced before new coding formats are introduced.

Preferred embodiments of the invention will now be described, by way of example only, with reference to the accompanying diagrammatic figures, in which:

FIG. 1 shows a known television signal broadcast system employing a set top box;

FIG. 2 shows a television signal broadcast system according to the invention;

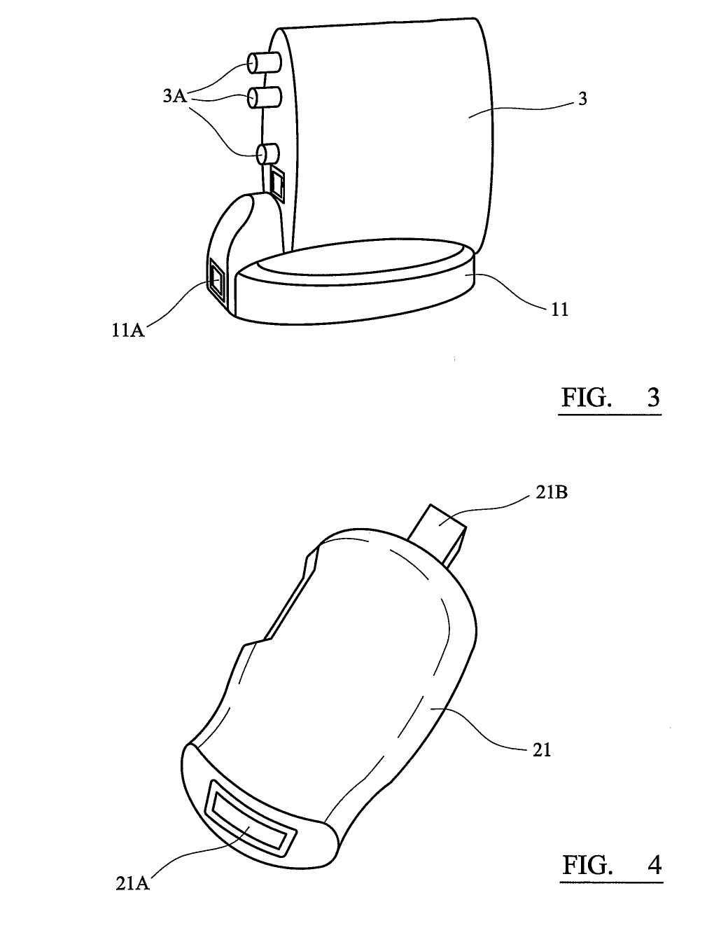

FIG. 3 shows a first example of an adapter according to the invention; and

FIG. 4 shows a second example of an adapter according to the invention.

As explained above with reference to FIG. 1, the usual known method of delivering a digital signal to a set-top box (STB) 3 and subsequently a display device such as a television set 4 is for a service provider 1 to produce an MPEG-2 encoded digital video stream, which is then sent, for example, by cable, terrestrial aerials, internet or satellite transmission, generally indicated by the network 2 to an STB 3. When the STB 3 receives the digital signal it decodes it and produces a decoded analogue signal suitable for display on the television set 4.

A first embodiment of the invention is shown in FIG. 2. FIG. 2 shows a delivery arrangement where a service provider 10 encodes a television programme as a digital video stream using a non-MPEG-2 format, for example the MPEG-4 format. MPEG-4 is the latest video standard developed by Moving Pictures Expert Group.

This MPEG-4 encoded digital video stream is transmitted through the network 2 and is received by an adapter 11. The adapter 11 receives the MPEG-4 digital video stream and supplies it to a media processor part of the adapter 11. The media processor converts the MPEG-4 digital video stream into an MPEG-2 digital video stream and this converted MPEG-2 digital video stream is output from the adapter 11 to the STB 3.

The STB 3 decodes the MPEG-2 digital video stream which it receives and outputs a decoded analogue signal suitable for display on the television set 4 as before.

Thus, the MPEG-4 signal is decoded, then recoded as an MPEG-2 signal, and passed to the STB. As far as the STB is concerned, the signal has only ever been MPEG-2. Thus, the STB is unaware of the earlier use of the MPEG-4 coding and operates exactly as before. In other words, the adapter 11 acts as a transcoder between the incoming network cable and the STB 3. If the signal is a conditional access signal, any conditional access layer will be decoded and recoded together with the rest of the signal so that the conditional access layer features are properly presented to the STB for the usual access control processing to be carried out.

The network 2 may be any suitable digital signal delivery means, including a cable network, the internet or terrestrial or satellite broadcasting.

Preferably the adapter 11 outputs the MPEG-2 digital video stream to the STB 3 at a higher bit rate than used by the received MPEG-4 digital video stream. This allows any loss of picture quality when converting to MPEG-2 from MPEG-4 format to be avoided. The MPEG-4 format allows greater compression of a video signal than the MPEG-2 format so that this higher bit rate is required to allow the same video signal to be carried without loss of quality. The distance between the adapter 11 and the STB 3 is very short, and in practice is effectively negligible. As a result the bit rate which can be achieved between the adapter 11 and the STB 3 can be much higher than can be delivered over the network 2 without difficulty.

For example, delivery of a television signal as an MPEG-4 encoded stream across the network 2 requires a bit rate of around 0.8 to 2.5 Mbit/sec while delivery of the same quality of video signal using MPEG-2 typically requires a bit rate of around 4 MBit/sec. Over the short distance connection between the adapter 11 and the STB 3 bit rates of 15 MBit/sec are easily achievable, providing ample capacity to support any required increase in data transfer rate.

The adapter 11 is preferably directly physically attached to the STB 3. This is preferred because this minimises the distance between the adapter 11 and the STB 3 and so allows the highest possible bit rate to be achieved between the adapter 11 and the STB 3. This advantage can alternatively be expressed as allowing a desired bit rate to be achieved between the adapter 11 and the STB 3 to be most easily achieved.

An example of a preferred embodiment of an adapter 11 is shown in FIG. 3. The adapter 11 is arranged to attach directly to the STB 3. The adapter 11 has a digital signal input socket 11A for connection to the network 2. The STB 3 has a plurality of analogue signal output sockets 3A for connection to a television set 4. The adapter 11 and STB 3 also have respective digital signal connectors (not visible in FIG. 3) which cooperate to form a high speed digital signal connection between them.

Alternatively, the adapter can be remote from the STB 3. In this case the adapter can be situated anywhere between the user's end of the network 2 and the STB 3.

An example of an adapter 21 according to this alternative embodiment of the invention is shown in FIG. 4. The adapter 21 has a digital signal input socket 21A for connection to the network 2 and a digital signal output socket 21B for connection to the STB 3. This embodiment has the advantage that without the need for direct connection the adapter 21 can cooperate with a range of different set top box designs of different shape, such as set top boxes produced by different manufacturers.

Conveniently, the digital signal input socket 11A or 21A for connection to the network 2 minors that on the STB 3.

The above examples describe use of the invention to transmit a television signal. The invention is equally applicable to transmission of a high definition television (HDTV) signal. An HDTV signal requires about five times the data rate of a standard television signal. Generally, around 12-20 Mbit/sec for MPEG-2 coding, and 5-12 Mbit/sec for MPEG-4 coding. This increase in data rate makes the required bit rate between the adapter 11 and the STB 3 more demanding, but the required bit rate is still be readily achievable over the short distance required.

The above examples describe the invention in terms of the use of MPEG-2 and MPEG-4 encoding. The present invention is not limited to these exemplary encoding methods and can be used where any change in encoding methods is made. For example, the present invention applies equally well to the use of other non-MPEG based advanced coding schemes such as the proprietary format from Microsoft (WM9, VC9, VC1), the On2 format or those of Real Networks Inc such as REAL 10. These all offer better compression ratios than MPEG-2 for the equivalent video image quality. However, as explained above MPEG-2 is currently the most common encoding method so it is expected that the adapters according to the present invention will most commonly be used to produce an MPEG-2 output.

An MPEG-2 stream typically operates at between 2.5 and 6 MBit/sec. At the lower end of this range the resultant picture quality is very poor and so it is very common to use rates of 4 MBit/sec so that the pictures are perceived as “better than VHS quality”. Generally this takes up a lot of the bandwidth available on the delivery mechanism. Newer technology is much more efficient with the encoding procedure and so produces a much smaller stream. For example, MPEG-4 operates at around 0.8 to 2.5 MBit/sec and so requires transfer of a much smaller amount of data, while delivering comparable levels of quality, allowing more video information to pass along the same delivery channel that the MPEG-2 stream filled.

A full description of the methods and processes which are employed by the MPEG coding/decoding system are beyond the scope of the present invention, but it is clear that a smaller, more efficient format is preferable and would be expected to quickly supersede the old MPEG-2 format. As explained above, the problem with such a change in format is that the owners of set top boxes and the service providers must replace the existing set top boxes with new ones able to cope with the new format. This is expensive and inconvenient for everyone and deters the service operators from making the switch to a better system.

As explained above, the existing STBs work typically on converting an MPEG-2 format to that understood by the display device such as a television. The present invention provides an adapter which converts the new format into MPEG-2 before passing it on to the STB.

1. An adapter for use with a digital to analog television signal decoder, the adapter comprising input means for receiving a digital video stream encoded according to a first format at a first bit rate, conversion means for converting the received digital video stream from the first format to a second format different from the first, and output means for outputting a converted digital video stream encoded according to the second format at a second bit rate higher than the first.

2. The adapter of claim 1, wherein the digital to analog television signal decoder is a set top box.

3. The adapter of claim 1, wherein the first format compresses the digital video stream more than the second format.

4. The adapter of claim 1, wherein the second format is MPEG-2.

5. The adapter of claim 1, wherein the first format is MPEG-4.

6. The adapter of claim 1, further comprising attachment means for attaching the adapter to the digital to analog television signal decoder.

7. The adapter of claim 6, wherein the output means includes a plug adapted to cooperate with a socket of the digital to analog television signal decoder.

8. The adapter of claim 1, wherein the input means is arranged to receive the digital video stream from a network
